(19) United States
(12) Patent Application Publication
(10) Pub. No.: US 2020/0254472 A1
(43) Pub. Date: Aug. 13, 2020

(54) LIQUID DISCHARGING DEVICE AND WIPING METHOD

(71) Applicants: Ayaka Tanaka, Kanagawa (JP); Akira Izutani, Osaka (JP); Takumi Atake, Kanagawa (JP)

(72) Inventors: Ayaka Tanaka, Kanagawa (JP); Akira Izutani, Osaka (JP); Takumi Atake, Kanagawa (JP)

(21) Appl. No.: 16/778,019

(22) Filed: Jan. 31, 2020

(30) Foreign Application Priority Data
Feb. 8, 2019 (JP) 2019-021374

(51) Int. Cl. B05B 15/50

(52) U.S. Cl. CPC B05B 15/50; B41J 2/16535

(57) ABSTRACT

A liquid discharging device includes a liquid comprising two or more types of alcohols, a liquid discharging head configured to discharge the liquid from a nozzle, and a wiping member configured to wipe a nozzle forming surface of the liquid discharging head, wherein the wiping member comprises two or more layers, wherein a first layer of the two or more layers that is in contact with the nozzle forming surface has a porosity smaller than a porosity of at least one layer of the two or more layers other than the first layer, wherein the first layer has a thickness thinner than the total thickness of the two or more layers other than the first layer.

### CROSS-REFERENCE TO RELATED APPLICATIONS

This patent application is based on and claims priority pursuant to 35 U.S.C. § 119 to Japanese Patent Application Nos. 2019-021374, filed on Feb. 8, 2019 in the Japan Patent Office, the entire disclosure of which is hereby incorporated by reference herein.

### BACKGROUND

### Technical Field

The present disclosure relates to a liquid discharging device and a wiping method.

### Description of the Related Art

In a liquid discharging device represented by an inkjet printer, foreign matter on a nozzle forming surface causes a problem such as defective discharging. Therefore, the nozzle forming surface requires regular cleaning. A cleaning method using a wiping member for cleaning a nozzle forming surface formed by combining a sheet-shaped wiping member represented by non-woven fabric and woven fabric has been proposed.

### SUMMARY

According to embodiments of the present disclosure, provided is a liquid discharging device which includes a liquid comprising two or more types of alcohols, a liquid discharging head configured to discharge the liquid from a nozzle, and a wiping member configured to wipe a nozzle forming surface of the liquid discharging head, wherein the wiping member comprises two or more layers, wherein a first layer of the two or more layers that is in contact with the nozzle forming surface has a porosity smaller than a porosity of at least one layer of the two or more layers other than the first layer, wherein the first layer has a thickness thinner than the total thickness of the two or more layers other than the first layer.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating an example of an image forming device incorporating a wiping device;

FIG. 2 is a diagram illustrating a perspective view of an example of a tank containing a liquid of the image forming device illustrated in FIG. 1;

FIG. 3 is a schematic diagram illustrating an example of the nozzle forming surface of a liquid discharging head;

FIG. 4 is a schematic diagram illustrating an example of a wiping device; and

FIG. 5 is a schematic diagram illustrating an example of the cross section of the sheet-like wiping member.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, provided is a liquid discharging device which is capable of easily removing dried matter of liquid adhering to a nozzle forming surface and reducing occurrence of discharging disturbance and non-discharging to enhance discharging stability.

A wiping device has been proposed in JP-2014-188900-A1 which relatively moves a liquid spraying head that sprays a liquid dispersion in which solid particles are dispersed in liquid against a wiping member to wipe off the liquid dispersion adhering to a nozzle forming surface. This wiping member has a first layer on the nozzle forming surface side and a second layer sandwiching the nozzle forming surface with the first layer. The first layer has a void that can guide liquid droplets as the dispersion medium of the liquid dispersion that adheres to the nozzle forming surface to the second layer due to the capillary action and can capture and contain the dispersoid of the liquid dispersion. The second layer absorbs the dispersion medium.

However, the liquid discharging device using a typical wiping member has a problem with removing attached matter dried on a nozzle forming surface. In addition, the liquid discharging device has a problem with discharging stability such as discharging disturbance or non-discharging during discharging liquid.

Next, embodiments of the present disclosure are described.

### Liquid Discharging Device And Wiping Method

The liquid discharging device according to an embodiment of the present disclosure includes a liquid, a liquid discharging device that discharges the liquid through a nozzle, a wiping device, etc. The wiping device includes a wiping member and others such as an optional cleaning liquid used during wiping. Moreover, the wiping method executed by the liquid discharging device including a wiping device includes wiping the nozzle forming surface and other optional processes such as applying a cleaning liquid. The wiping device causes the wiping member to contact the nozzle forming surface of a liquid discharging head that discharges a liquid from a nozzle to wipe the nozzle forming surface. In the present embodiment, wiping refers to relative moving of the wiping member against the liquid discharging head while bringing the wiping member into contact with the nozzle forming surface. By wiping the nozzle forming surface using the wiping member, for example, it is possible to remove dried liquid matter adhering to the nozzle forming surface from the nozzle forming surface. In addition, for example, it is possible to absorb extra liquid overflowing from the nozzle to remove it from the nozzle forming surface.

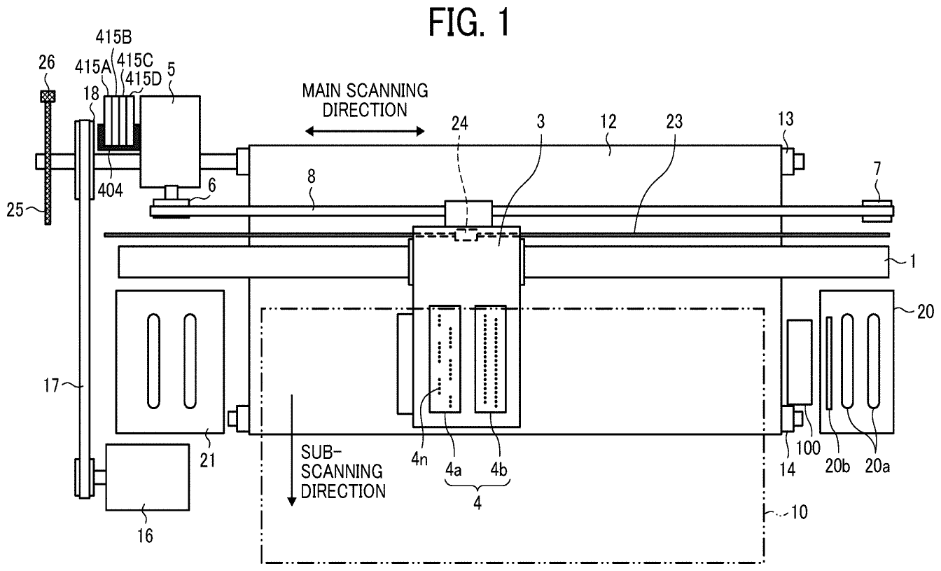

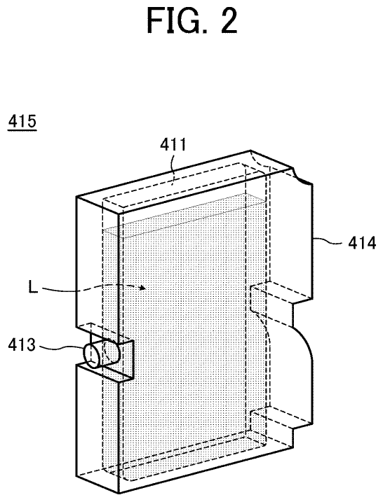

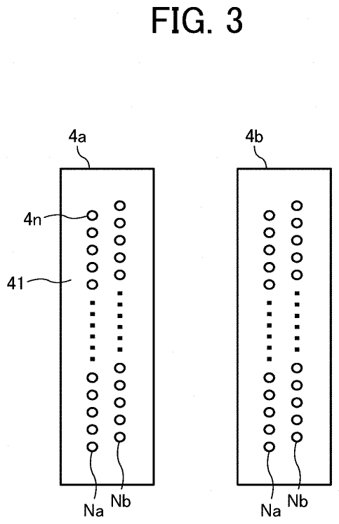

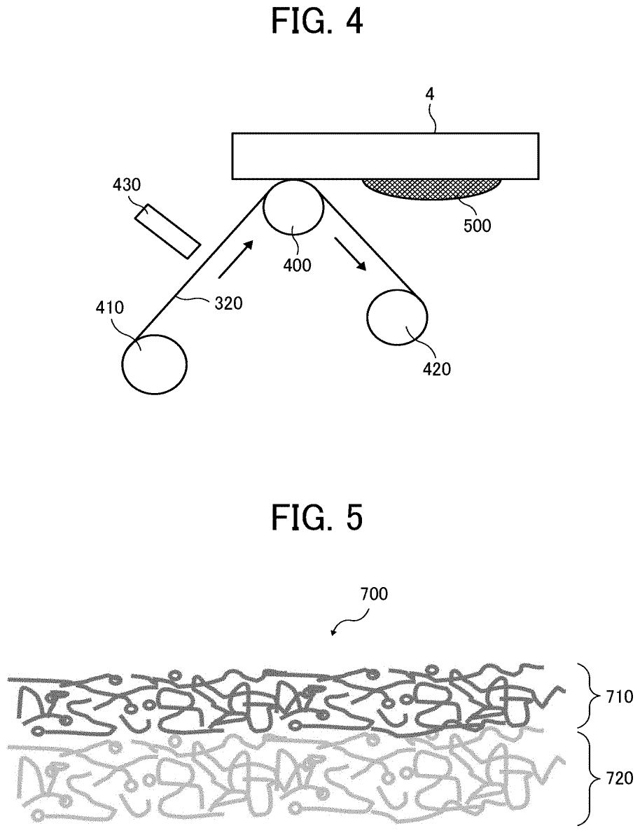

Next, the liquid discharging device and the wiping device will be described taking an image forming device as an example of a liquid discharging device incorporating the wiping device with reference to FIGS. 1 to 4. The image forming device discharges ink as an example of the liquid. FIG. 1 is a schematic diagram illustrating an example of an image forming device incorporating a wiping device. FIG. 3 is a schematic diagram illustrating an example of the nozzle forming surface of a liquid discharging head. FIG. 4 is a schematic diagram illustrating an example of the wiping device.

The image forming device illustrated in FIG. 1 is a serial type liquid discharging device. The image forming device includes a carriage 3 which is movably held by a main guide member 1 and a sub-guide member, that are bridged between the left and right side plates and a liquid containers 415A, 415B, 415C, and 415D that contain liquids such as inks of Y, M, C, and K. A main scanning motor 5 drives the carriage 3 to reciprocate in the main scanning direction (carriage moving direction) via a timing belt 8 stretched around a drive pully 6 and a driven pully 7. The carriage 3 carries recording heads 4a and 4b (referred to as recording head 4 if distinction thereof is not necessary) as examples of the liquid discharging heads. The recording head 4 discharges color ink of, for example, yellow (Y), cyan (C), magenta (M), and black (K) supplied from liquid containers A to D. The recording head 4 carries nozzle arrays, each having multiple nozzles 4n disposed along the sub-scanning direction vertical to the main scanning direction with the ink discharging direction downward.

As illustrated in FIG. 3, the recording head 4 includes two nozzle arrays Na and Nb, each including multiple nozzles 4n on a nozzle forming surface 41. As the liquid discharging head constituting the recording head 4, for example, it is possible to use a piezoelectric actuator such as a piezoelectric element and a thermal actuator that utilizes the phase change caused by film boiling of liquid by using an electric heat conversion element such as a heat element.

The image forming device illustrated in FIG. 1 has a conveyor belt 12 serving as a conveying device to convey a sheet 10 by electrostatic adsorption at the position facing the recording head 4. The conveyor belt 12 takes an endless form and stretched around a conveyor roller 13 and a tension roller 14. The conveyor belt 12 is moved around in the sub-scanning direction by the conveyor roller 13 rotationally driven by a sub-scanning motor 16 via a timing belt 17 and a timing pully 18. This conveyor belt 12 is charged (charges are applied) by a charging roller while circulating.

At one end in the main-scanning direction of the carriage 3, a maintenance and recovery assembly 20 configured to maintain and recover the recording head 4 is disposed lateral to the conveyor belt 12. On the other end, a dummy discharging receiver 21 configured to receive dummy discharging by the recording head 4 is disposed lateral to the conveyor belt 12. The maintenance and recovery assembly 20 includes, for example, a capping member 20a to cap the nozzle forming surface (surface on which the nozzle is formed) 41 of the recording head 4, a wiping assembly 20b that wipes the nozzle forming surface 41, and the dummy discharging receiver 21 that receives droplets not used for image forming.

Further, the image forming device includes an encoder scale 23 that has a predetermined pattern and is stretched between both side plates along the main scanning direction of the carriage 3. Further, the carriage 3 includes an encoder sensor 24 formed of a transmission type photo sensor that reads the pattern of the encoder scale 23. These encoder scale 23 and the encoder sensor 24 constitute a linear encoder (main scanning encoder) that detects the moving of the carriage 3.

In addition, a code wheel 25 is mounted onto the shaft of the conveyor roller 13, and an encoder sensor 26 is provided which has a transmissive photosensor that detects the pattern formed on the code wheel 25 These code wheel 25 and encoder sensor 26 constitute a rotary encoder (sub-scanning encoder) that detects the moving and the position of the conveyor belt 12.

In the image forming device having such a configuration, the sheet 10 is fed onto the charged conveyor belt 12, adsorbed thereto, and conveyed along the sub-scanning direction in accordance with the rotation of the conveyor belt 12. By driving the recording head 4 in response to an image signal while moving the carriage 3 in the main-scanning direction, ink droplets are discharged onto the sheet 10 standing still to record an image in an amount of one line. After the sheet 10 is conveyed in a predetermined amount, the next line is recorded. On receiving a signal indicating that the recording is finished or the rear end of the sheet 10 has reached the image recording region, the recording operation stops and the sheet 10 is ejected to an ejection tray.

In addition, the carriage 3 is moved to the maintenance and recovery assembly 20 in the printing (recording) standby mode to clean the recording head 4 by the maintenance and recovery assembly 20. Alternatively, the recording head 4 may not be moved and the maintenance and recovery assembly 20 may move to clean the recording head 4. The recording head 4 illustrated in FIG. 1 has two nozzle arrays Na and Nb, each including multiple nozzles 4n, as illustrated in FIG. 3. The nozzle array Na of the recording head 4a discharges black (K) liquid droplets and the other nozzle array Nb discharges cyan (C) liquid droplets. The nozzle array Na of the recording head 4b discharges magenta (M) liquid droplets and the other nozzle array Nb discharges yellow (Y) liquid droplets.

An example of the wiping device is the wiping assembly 20b that wipes the nozzle forming surface 41. As illustrated in FIG. 4, the wiping assembly 20b includes a sheet-like wiping member 320, which is an example of the wiping member, a delivery roller 410 that delivers the sheet-like wiping member 320, a cleaning liquid dripping device 430, which is an example of the cleaning liquid application device that applies a cleaning liquid to the sheet-like wiping member 320 delivered, a pressing roller 400 as an example of pressing the sheet-like wiping member 320 to which the cleaning liquid has been applied against the nozzle forming surface 41, and a reel-up roller 420 that collects the sheet-like wiping member 320 used for wiping. The cleaning liquid is supplied from a cleaning liquid storage container that stores the cleaning liquid through a cleaning liquid supply tube provided with a pump in the middle for supplying the cleaning liquid. In addition to the sheet-like wiping member 320, the wiping assembly 20b that wipes the nozzle forming surface 41 may optionally include a rubber blade, etc., to wipe the nozzle forming surface 41. The pressing roller 400 uses a spring to adjust the distance between a cleaning unit and the nozzle forming surface 41, thereby adjusting the pressing force. The pressing member is not limited to a roller but can be a fixed member made of plastic or rubber. When the wiping assembly 20b includes a rubber blade, etc., an assembly for bringing the rubber blade, etc., into contact with the sheet-like wiping member 320 is provided to impart a cleaning ability of the rubber blade, etc., to the sheet-like wiping member 320. Moreover, although it is preferable that the sheet-like wiping member 320 be held in a roll-up state as illustrated in FIG. 4 in terms of downsizing, the sheet-like wiping member 320 is not limited thereto and may be folded. The cleaning liquid applying device is not limited to the cleaning liquid dripping device. For example, it includes a cleaning liquid applying roller for applying the cleaning liquid with a roller and a cleaning liquid applying spray for applying the cleaning liquid with a spray. Further, the cleaning liquid application executed by the cleaning liquid application device is not particularly limited as long as the cleaning liquid can be applied to the nozzle forming surface 41. In addition to the indirect cleaning liquid application via the cleaning liquid application device as in the embodiment described above, it is possible to directly apply the cleaning liquid to the nozzle forming surface 41. However, it is preferable to indirectly apply the cleaning liquid via a cleaning liquid applying device. The wiping device does not always necessarily include the cleaning liquid dripping device 430.

In the present embodiment, it is preferable that, as an example of the wiping, after applying the cleaning liquid to the sheet-like wiping member 320 in a predetermined amount, the recording head 4 and the wiping assembly 20b relatively move to each other while the sheet-like wiping member 320 is pressed against the nozzle forming surface 41 to wipe off foreign matter 500 adhering to the nozzle forming surface 41. Examples of the foreign matter 500 adhering to the nozzle forming surface 41 include, but are not limited to, mist ink produced during discharging of the ink from the nozzles 4n, ink adhering to the nozzle forming surface 41 when the ink is sucked from the nozzles 4n during, for example, cleaning, adhesion ink which is mist ink or ink adhering to the cap member dried on the nozzle forming surface 41, and paper dust produced from printed matter. In the present embodiment, the foreign matter 500 is wiped off after the cleaning liquid is applied to the wiping member that does not contain the cleaning liquid. However, a wiping member that contains the cleaning liquid in advance obviates the need for a cleaning liquid applying device. Moreover, the cleaning liquid can be applied to a portion other than the wiping member. For example, the cleaning liquid can be directly applied to the nozzle forming surface 41. That is, the cleaning liquid applied to the nozzle forming surface means all types of cleaning liquids applied to the nozzle forming surface. For example, it includes a cleaning liquid directly applied to the nozzle forming surface and a cleaning liquid indirectly applied to the nozzle forming surface via a wiping member containing the cleaning liquid. The latter is preferable to the former. Furthermore, if the ink is assumed to be dried and adhere to the nozzle forming surface as a result of a long standby period of time, etc., a configuration is preferable which can wipe the nozzle forming surface multiple times with the wiping member containing the cleaning liquid to remove the dried ink. In addition to the wiping of the nozzle forming surface using the cleaning liquid, it is possible to add wiping the nozzle forming surface without using a cleaning liquid. It is also possible to wipe the nozzle forming surface without using a cleaning liquid.

### Wiping Member

Next, the wiping member will be described with reference to FIG. 5. FIG. 5 is a schematic diagram illustrating an example of the cross section of the wiping member having a sheet-like form. A wiping member 700 illustrated in FIG. 5 is, for example, a double-layer non-woven fabric and has a first layer 710 that is brought into contact with the nozzle forming surface 41 to wipe the nozzle forming surface 41 of a liquid discharging head and a second layer 720 (layer other than the first layer) having a rear surface that is not brought into contact with the nozzle forming surface 41. The wiping member 700 may take a three-layer structure lined with a film to prevent strike through of ink and reinforce the strength of the wiping member or a multi-layer structure having multiple absorbing layers having different absorptivity, which are provided as the second layer or thereafter. That is, the wiping member has at least two layers and at least one more layer other than the first layer.

Examples of materials constituting the wiping member may include, but are not limited to, woven fabric, knitted fabric, and porous materials in addition to non-woven fabric. In particular, it is preferable to use a non-woven fabric because the thickness and porosity can be controlled relatively easily and various types of fibers can be easily mixed. Materials of fibers for non-woven fabric, woven fabric, knitted fabric, etc. include, but are not limited to, cotton, hemp, silk, pulp, nylon, vinylon, polyester, polypropylene, polyethylene, rayon, cupra, acrylic, and polylactic acid. Non-woven fabric may be made not only of one type of fiber but also be of mixed plural types of fibers. Examples of the porous materials include, but are not limited to, polyurethane, polyolefin, and PVA. A method of manufacturing a non-woven fabric wiping member will be described. Examples of the method of forming a non-woven fabric include, but are not limited to, wet, dry, spun-bond, melt-blown and flash spinning. Moreover, the non-woven fabric can be bonded by, for example, methods such as spun lace, needle punch, thermal bond, chemical bond, etc. In the spun lace method, jet water stream is sprayed onto accumulated fibers to entangle the fibers due to the pressure, thereby bonding the fibers like a sheet. The needle-punch method forms a non-woven fabric by stabbing a needle with a protrusion called a barb into accumulated fibers several ten times or more to mechanically intertwine the fibers.

Further, when the porosity of the first layer is smaller than the porosity of at least one layer other than the first layer, scraping property for the attached ink is improved and the attached ink wiping property is improved. The porosity is calculated as follows:

Porosity=1−apparent density/true density Relationship 1

Regarding sheet-shaped non-woven fabric, etc., the “true density” is the true density of the fiber forming the sheet, and “apparent density” can be obtained by dividing the basis weight of the sheet-shaped material by thickness, i.e., [basis weight/thickness].

When a wiping member is thin and has a small porosity, it has a good scraping property. However, a wiping member having such properties cannot retain liquid components such as ink and cleaning liquid. As a result, cleaning properties of a single layered wiping member are insufficient. Therefore, it is preferable to provide a layer other than the first layer capable of holding the liquid component therein. In addition, for the layers of the wiping member, as described above, when the porosity of the first layer is determined to be smaller than the porosity of at least one of the one or more layers other than the first layer, ability of wiping off attached ink is enhanced. In addition, when the porosity of the first layer is determined to be smaller than the porosity of all of the one or more layers other than the first layer, ability of wiping off attached ink is enhanced. The thickness of the first layer is smaller than the total thickness of the layers other than the first layer. This allows improving wiping of attached ink.

The porosity of the first layer is preferably from 0.60 to 0.85 and more preferably from 0.75 to 0.80. When the porosity of the first layer is from 0.60 to 0.85, the ability of wiping off the attached ink can be improved and preventing the wiping member from becoming filmy that is not penetrable, thereby ameliorating permeability.

The porosity of at least one of the one or more layers is preferably from 0.80 to 0.99. When the porosity of the layers other than the first layer is within the above range, the liquid absorbency can be improved. By combining the first layer and the layers other than the first layer, the wiping member can strike a balance between scraping ability and liquid absorption, thereby improving wiping ability. The porosity of all the layers other than the first layer is preferably within the range specified above.

The thickness of the wiping member is preferably from 0.1 to 3.0 mm and more preferably from 0.2 to 0.7 mm. Since the thickness of the wiping member is 0.1 mm or more, a saturated water absorption amount of the liquid per area of the wiping member is sufficient and the target ink can be sufficiently absorbed. Further, since the thickness of the wiping member is 3.0 mm or less, the liquid component of the ink can be still transferred from the first layer to the layers other than the first layer without degrading the absorption power of the layers other than the first layer. Therefore, the device can be down-sized.

### Liquid

The ink, which is an example of the liquid carried in the liquid discharging device, is described below. The liquid is not limited to ink applied to a recording medium and may be, for example, a pre-processing liquid applied to a recording medium before ink discharging, and a post-processing liquid applied to an ink-discharged surface of a recording medium after ink discharging.

The ink as an example of the liquid contains two or more types of alcohols as organic solvents and other optional components such as organic solvents, water, coloring materials, resins, surfactants, defoaming agents, preservatives and fungicides corrosion inhibitors, and pH regulators. When the liquid contains two or more types of alcohols, it is possible to reduce occurrences of discharging disturbance and non-discharging when the liquid is discharged from a liquid discharging device.

Each ink accommodating unit 411 of ink containers (tanks) 415 (415A, 415B, 415C, and 415D) of each color ink L of black (K), cyan (C), magenta (M), and yellow (Y) is formed of, for example, aluminum laminate film. The ink accommodating unit 411 is housed in a plastic accommodating housing 414. Due to this configuration, the ink container 415 is used as an ink cartridge for each color. A cartridge holder 404 is provided to the ink discharging device. The ink container 415 is detachably attached to the ink cartridge holder 404. This enables each ink outlet 413 of the ink container 415 to communicate with the discharging head 4 for each color via a supplying tube 436 for each color so as to discharge the ink from the discharging head 4 onto a recording medium.

### Organic Solvent

The organic solvent contains two or more types of alcohols.

Specific examples of the alcohol include, but are not limited to, polyhydric alcohols such as ethylene glycol, diethylene glycol, 1,2-propanediol, 1,3-propane diol, 1,2-butanediol, 1,3-butanediol, 1,4-butanediol, 2,3-butanediol, 3-methyl-1,3-butanediol, trethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petriol. Of these, in terms of improving drying property of the liquid, it is preferable that at least one of the two or more alcohols be a glycol having a main chain length of 4 or less. By using a glycol having a main chain length of 4 or less, the drying property of the liquid applied to a recording medium is improved, thereby ameliorating productivity. However, when the drying property of a liquid ameliorates and such liquid is attached to the nozzle forming surface of a liquid discharging head, the liquid is easily dried, thereby more easily forming attached matter. Therefore, by using the liquid discharging device of the present embodiment having the wiping member, it is easy to remove the attached matter adhering to the nozzle forming surface, which makes it possible to strike a balance between ease of removing the attached matter and improvement in productivity.

Specific examples of the glycol having a main chain length of 4 or less include, but are not limited to, ethylene glycol, diethylene glycol, 1,2-propanediol, 1,3-propanediol, 1,2-butanediol, 1,3-butanediol, 4-butanediol, 2,3-butanediol, 2-methyl-1,2-butanediol, 2-methyl-1,2-butanediol, 2-methyl-1,3-butanediol, 3-methyl-1, 3 -butanediol, and 2-methyl-1,4-butanediol. Preferably, all the alcohols contained in the liquid are glycols having a main chain length of 4 or less.

Examples of the organic solvent include, but are not limited to, ethers such as polyhydric alkyl ethers and polyhydric arylethers, nitrogen-containing heterocyclic compounds, amides, amines, and sulfur-containing compounds. Specific examples include, but are not limited to, polyhydric alcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether, polyhydric alcohol aryl ethers such as ethylene glycol monophenyl ether and wthylene glycol monobenzyl ether, nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone, amides such as formamide, N-methylform amides, N, N-dimethylformamide, 3-methoxy-N,N -dimethylpropionamide, 3-butoxy-N, N-dimethylpropionamide, amines such as monoethanolamine, diethanolamine, and triethylamine, sulfur-containing compounds such as dimethyl sulfoxide, sulfolane, and thiodiethanol, propylene carbonate, and ethylene carbonate.

To serve as a humectant and impart a good drying property, it is preferable to use an organic solvent having a boiling point of 250 degrees C. or lower.

Polyol compounds having eight or more carbon atoms and glycol ether compounds are also suitable.

Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyol alkylethers such as ethyleneglycol monoethylether, ethyleneglycol monobutylether, diethyleneglycol monomethylether, diethyleneglycol monoethylether, diethyleneglycol monobutylether, tetraethyleneglycol monomethylether, and propyleneglycol monoethylether; and polyol arylethers such as ethyleneglycol monophenylether and ethyleneglycol monobenzylether.

The proportion of the organic solvent in the cleaning liquid is not particularly limited and can be suitably selected to suit to a particular application. For example, it is preferably from 10 to 60 percent by mass and more preferably from 20 to 60 percent by mass.

### Water

The proportion of water in the liquid is not particularly limited and can be suitably selected to suit to a particular application. In terms of drying property and discharging reliability of the liquid, the proportion is preferably from 10 to 90 percent by mass and more preferably from 20 to 60 percent by mass.

### Coloring Material

The coloring material has no particular limit. For example, pigments and dyes are suitable. As the pigment, inorganic pigments or organic pigments can be used. These can be used alone or in combination. In addition, it is possible to use a mixed crystal as the pigment.

As the pigments, for example, black pigments, yellow pigments, magenta pigments, cyan pigments, white pigments, green pigments, orange pigments, gloss pigments, and metallic pigments of gold, silver, etc., can be used.

As the inorganic pigments, in addition to titanium oxide, iron oxide, calcium carbonate, barium sulfate, aluminum hydroxide, barium yellow, cadmium red, and chrome yellow, carbon black manufactured by known methods such as contact methods, furnace methods, and thermal methods can be used.

As the organic pigments, it is possible to use azo pigments, polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black can be used. Of those pigments, pigments having good affinity with solvents are preferable. Also, hollow resin particles and hollow inorganic particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, CI. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51; C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63; C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.1. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The proportion of the coloring material in the liquid is preferably from 0.1 to 15 percent by mass and more preferably from 1 to 10 percent by mass in terms of enhancement of image density, fixability, and discharging stability.

To obtain a liquid such as an ink by dispersing a pigment, for example, a hydrophilic functional group is introduced into a pigment to prepare a self-dispersible pigment, the surface of a pigment is coated with a resin followed by dispersion, or a dispersant is used to disperse a pigment.

To prepare a self-dispersible pigment by introducing a hydrophilic functional group into a pigment, for example, it is possible to add a functional group such as a sulfone group and a carboxyl group to the pigment (e.g., carbon) to disperse the pigment in water.

To coat the surface of a pigment with a resin, the pigment is encapsulated by microcapsules to make the pigment dispersible in water. This can be referred to as a resin-coated pigment. In this case, all the pigments to be added to the liquid are not necessarily entirely coated with a resin. Pigments partially or wholly uncovered with a resin are allowed to be dispersed in the liquid unless such pigments have an adverse impact.

In a method of using a dispersant to disperse a pigment, for example, a known dispersant having a small molecular weight or a large molecular weight, which is represented by a surfactant, is used to disperse the pigment in a liquid. As the dispersant, it is possible to use, for example, an anionic surfactant, a cationic surfactant, a nonionic surfactant, an amphoteric surfactant, etc. depending on a pigment. Also, a nonionic surfactant (RT-100, manufactured by TAKEMOTO OIL & FAT CO., LTD.) and a formalin condensate of naphthalene sodium sulfonate are suitable as the dispersant. Those can be used alone or in combination.

### Pigment Dispersion

It is possible to obtain a liquid such as ink by mixing materials such as a resin, water, and an organic solvent with a pigment. Also, a pigment dispersion is obtained by mixing a pigment, water, a dispersant, etc., to obtain a pigment dispersion and further mixing the pigment dispersion with materials such as a resin, water, an organic solvent, etc., to manufacture a liquid such as an ink. The pigment dispersion is obtained by mixing and dispersing water, a pigment, a pigment dispersant, and other optional components and controlling the particle size. It is good to use a dispersing device for dispersion.

The particle diameter of the pigment in the pigment dispersion has no particular limit. For example, the maximum frequency is preferably from 20 to 500 nm and more preferably from 20 to 150 nm in the maximum number conversion to improve dispersion stability of the pigment and ameliorate discharging stability and the image quality such as image density. The particle diameter of the pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and increasing image density, the proportion is preferably from 0.1 to 50 percent by mass and more preferably from 0.1 to 30 percent by mass.

It is preferable that the pigment dispersion be filtered with a filter, a centrifuge, etc., to remove coarse particles followed by degassing.

The particle diameter of the solid portion in the liquid has no particular limit and can be selected to suit to a particular application. The maximum frequency of the particle diameter of the solid portion in the liquid is preferably from 20 to 1000 nm and more preferably from 20 to 150 nm in the maximum number conversion to enhance discharging stability and image quality such as image density. The solid portion includes resin particulate, pigment particulate, etc. The particle diameter can be measured by using a particle size analyzer (Nanotrac Wave-UT151, manufactured by MicrotracBEL Corp).

### Resin

The type of the resin contained in the liquid has no particular limit and can be suitably selected to suit to a particular application. Examples include, but are not limited to, urethane resins, polyester resins, acrylic-based resins, vinyl acetate-based resins, styrene-based resins, butadiene-based resins, styrene-butadiene-based resins, vinyl chloride-based resins, acrylic styrene-based resins, and acrylic silicone-based resins.

Resin particulate made of such resins can be also used. It is possible to mix a resin emulsion in which such resin particles are dispersed in water as a dispersion medium with materials such as a coloring material and an organic solvent to obtain a liquid such as an ink. It is possible to use suitably-synthesized resin particles as the resin particle. Alternatively, the resin particle available on the market can be used. These resin particulates can be used alone or in combination.

The mean volume diameter (volume average particle diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to obtain good fixability and image robustness.

The mean volume diameter can be measured by using, for example, a particle size analyzer (Nanotrac Wave-UT151, manufactured by MicrotracBEL Corp.).

The proportion of the resin in the liquid is not particularly limited and can be suitably selected to suit to a particular application. In terms of fixability and storage stability of the liquid, it is preferably from 1 to 30 percent by mass and more preferably from 5 to 20 percent by mass to the total amount of the ink.

The particle diameter of the solid portion in the liquid has no particular limit and can be selected to suit to a particular application. The maximum frequency of the particle diameter of the solid portion in the liquid is preferably from 20 to 1000 nm and more preferably from 20 to 150 nm in the maximum number conversion to enhance discharging stability and image quality such as image density. The solid portion includes resin particulate, pigment particulate, etc. The particle diameter can be measured by using a particle size analyzer (Nanotrac Wave-UT151, manufactured by MicrotracBEL Corp).

### Additive

The liquid may further optionally include a surfactant, a defoaming agent, a preservative and fungicide, a corrosion inhibitor, a pH regulator, etc.

### Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. Of these, silicone-based surfactants not decomposed even in high pH environment are preferable. Examples of the silicone-based surfactant include side-chain modified polydimethylsiloxane, both-terminal modified polydimethylsiloxane, one-terminal-modified polydimethylsiloxane, and both-chain both-terminal modified polydimethylsiloxane. As the modification group, it is particularly preferable to select a polyoxyethylene group or polyoxyethylene polyoxypropylene group because these demonstrate good properties as aqueous surfactants. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not easily produce foams.

Specific examples of the perfluoroalkyl sulfonic acid compounds include, but are not limited to, perfluoroalkyl sulfonic acid and salts of perfluoroalkyl sulfonic acid. Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the ampholytic surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application.

Specific examples include, but are not limited to, side-chain-modified polydimethyl siloxane, both distal-end-modified polydimethyl siloxane, one-distal-end-modified polydimethyl siloxane, and side-chain-both-distal-end-modified polydimethyl siloxane. In particular, a polyether-modified silicone-based surfactant having a polyoxyethylene group or a polyoxyethylene polyoxypropylene group is particularly preferable because such a surfactant demonstrates good property as an aqueous surfactant.

Any suitably synthesized surfactant and any product available on the market is suitable. Products available on the market can be obtained from BYK-Chemie GmbH, Shin-Etsu Chemical Co., Ltd., Dow Corning Toray Co., Ltd., NIHON EMULSION Co., Ltd., Kyoeisha Chemical Co., Ltd., etc.

The polyether-modified silicon-based surfactant has no particular limit and can be suitably selected to suit to a particular application. For example, a compound is usable in which the polyalkylene oxide structure represented by the following Chemical formula S-1 is introduced into the side chain of the Si site of dimethyl polysiloxane.

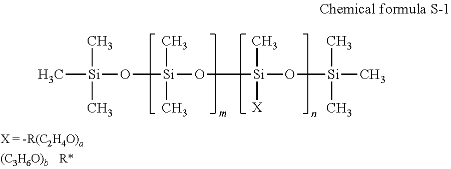

In Chemical formula S-1, “m”, “n”, “a”, and “b” each, respectively independently represent integers, R represents an alkylene group, and R′ represents an alkyl group.

Specific examples of the polyether-modified silicone-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by Momentive Performance Materials Inc.).

The fluorochemical surfactant is preferably a compound having 2 to 16 fluorine-substituted carbon atoms and more preferably a compound having 4 to 16 fluorine-substituted carbon atoms.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain. Of these, polyoxyalkylene ether polymer compounds having a perfluoroalkyl ether group in its side chain are preferable because they do not easily foam and the fluorosurfactant represented by the following Chemical formula F-1 or Chemical formula F-2 is preferable.

CF₃CF₂(CF₂CF₂)ₘ—CH₂CH₂O(CH₂CH₂O)ₙH Chemical formula F-1

In the compound represented by Chemical formula F-1, m is preferably 0 or an integer of from 1 to 10 and n is preferably 0 or an integer of from 1 to 40.

C [symbol] F₂ₙ₊₁—CH₂CH(OH)CH₂—O—(CH₂CH₂O) [symbol] —Y Chemical formula F-2

In the compound represented by the Chemical formula F-2, Y represents H or CₘF₂ₘ₊₁, where m represents an integer of from 1 to 6, or CH₂CH(OH)CH₂—CₘF₂ₘ₊₁, where m represents an integer of from 4 to 6, or CₚH₂ₚ₊₁, where p is an integer of from 1 to 19. n represents an integer of from 1 to 6. a represents an integer of from 4 to 14.

As the fluorochemical surfactant, products available on the market may be used. Specific examples include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and CapstoneTM FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNETM DSN-403N (manufactured by DAIKIN INDUSTRIES, Ltd.). Of these, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNETM DSN-403N (manufactured by DAIKIN INDUSTRIES, Ltd.) are particularly preferable.

The proportion of the surfactant in the liquid is not particularly limited and can be suitably selected to suit to a particular application. For example, it is preferably from 0.001 to 5 percent by mass and more preferably from 0.05 to 5 percent by mass.

### Defoaming Agent

The defoaming agent has no particular limit. For example, silicon-based defoaming agents, polyether-based defoaming agents, and aliphatic acid ester-based defoaming agents are suitable. These can be used alone or in combination. Of these, silicone-based defoaming agents are preferable in terms of the effect of foam breaking.

### Preservatives and Fungicides

The preservatives and fungicides are not particularly limited. A specific example is 1,2-benzisothiazoline-3-one.

### Corrosion Inhibitor

The corrosion inhibitor has no particular limitation. Specific examples include, but are not limited to, acid sulfites and sodium thiosulfates.

### pH Regulator

The pH regulator has no particular limit as long as it can control pH to be not lower than 7. Specific examples include, but are not limited to, amines such as diethanol amine and triethanol amine.

### Properties of Liquid

Properties of the liquid are not particularly limited and can be suitably selected to suit to a particular application. For example, viscosity, surface tension, and pH are preferably in the following ranges.

Viscosity of the liquid at 25 degrees C. is preferably from 5 to 30 mPa·s and more preferably from 5 to 25 mPa·s to improve print density and text quality and obtain good dischargeability. Viscosity can be measured by, for example, a rotatory viscometer (RE-80L, manufactured by TOKI SANGYO CO., LTD.). The measuring conditions are as follows:

Standard cone rotor (1°34′×R24)
Sample liquid amount: 1.2 mL
Rotational frequency: 50 rotations per minute (rpm)
25 degrees C.
Measuring time: three minutes.

The surface tension of the liquid is preferably 35 mN/m or less and more preferably 32 mN/m or less at 25 degrees C. in terms that the ink is suitably leveled on a recording medium and the drying time of the liquid is shortened. pH of the liquid is preferably from 7 to 12 and more preferably from 8 to 11 in terms of prevention of corrosion of metal material in contact with liquid.

### Cleaning Liquid

The cleaning liquid that may be contained in the wiping device preferably contains, for example, an organic solvent, water, a surfactant, a defoaming agent, a preservatives and fungicides, a corrosion inhibitor, and a pH regulator. The wiping member wipes off this cleaning liquid after the cleaning liquid is directly or indirectly applied to the nozzle forming surface so that viscosity of attached matter formed on the nozzle forming surface decreases, thereby easily removing the attached matter. It is also preferable to accommodate the cleaning liquid in a cleaning liquid container, which is installed onto a wiping device.

The organic solvent, water, surfactant, defoaming agent, preservatives and fungicides, corrosion inhibitors, and pH regulators that may be contained in the cleaning liquid can be used in the same manner as in the liquid such as the ink. Therefore, the description is omitted.

### Recording Medium

The recording medium to which the liquid is applied is not particularly limited. Plain paper, gloss paper, special paper, cloth, etc. are usable. Also, good images can be formed on a non-permeable substrate.

The non-permeable substrate has a surface with low moisture permeability and low absorbency and includes a material having myriad of hollow spaces inside but not open to the outside. To be more quantitative, the substrate has a water-absorption amount of 10 mL/m² or less within 30 msec^{1/2} of the contact of the ink according to Bristow method.

For example, plastic films such as vinyl chloride resin film, polyethylene terephthalate (PET) film, polypropylene film, polyethylene film, and polycarbonate film are suitably used as the non-permeable substrate.

The recording media are not limited to articles used as typical recording media. It is suitable to use building materials such as wall paper, floor material, and tiles, cloth for apparel such as T-shirts, textile, and leather as the recording medium. In addition, the configuration of the paths through which the recording medium is conveyed can be adjusted to use ceramics, glass, metal, etc.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

### Preparation of Ink

### Preparation of Black Pigment Dispersion

100 g of carbon black (SEAST SP, SRF-LS, manufactured by TOKAI CARBON CO., LTD.) was added to 3,000 mL of 2.5 normal sodium hypochlorite followed by stirring at 300 rpm at 60 degrees C. Subsequent to reaction for ten hours for oxidation treatment, a pigment in which a carboxylic acid group was placed on the surface of carbon black was obtained. The reaction liquid was filtrated and the thus-filtered carbon black was neutralized with sodium hydroxide solution followed by ultra-filtration. Thereafter, the thus-obtained pigment dispersion and deionized water were subject to ultrafiltration by dialysis membrane and further ultrasonic dispersion to obtain black pigment dispersion having a pigment solid portion concentrated to 20 percent with a mean volume diameter of 100 nm.

### Preparation of Resin Emulsion

Boncoat CF-6140 (manufactured by DIC Corporation) was used as an acrylic resin emulsion.

### Preparation of Black Ink

A black ink was prepared by mixing and stirring according to the formulation shown in Table 1 below and filtering with a 0.5 μm polypropylene filter. The following surfactants and mildew-proofing agent were used.

FS-300 (fluorochemical surfactant, manufactured by E. I. du Pont de Nemours and Company)
PROXEL LV, manufactured by AVECIA Inc.

TABLE 1

| | Ink | Ink | Ink | Ink |
|---|---|---|---|---|
| | Prepa- | Prepa- | Prepa- | Prepa- |
| | ration | ration | ration | ration |
| | Example 1 | Example 2 | Example 3 | Example 4 |
| Black pigment dispersion | 10.0 | 10.0 | 10.0 | 10.0 |
| (solid mass) | | | | |
| Acrylic resin emulsion | 8.0 | 8.0 | 8.0 | 8.0 |
| (solid mass) | | | | |
| 1,2-butanediol | 30.0 | | | 30.0 |
| 1,2-hexanediol | | 30.0 | 30.0 | |
| 2-methyl-1,3- | 5.0 | 5.0 | | |
| propanediol | | | | |
| 2-methyl-2,4- | | | 5.0 | |
| pentanediol | | | | |
| 2-pyrroridone | 5.0 | 5.0 | 5.0 | 5.0 |
| FS-300 | 2.0 | 2.0 | 2.0 | 2.0 |
| PROXEL LV | 0.1 | 0.1 | 0.1 | 0.1 |
| Deionized water | Balance | Balance | Balance | Balance |
| Total amount | 100 | 100 | 100 | 100 |

### Manufacturing of Wiping Member

A sheet-like non-woven fabric or film made of the material shown in Table 2 below was prepared and the first layer and the second layer were pasted to manufacture a wiping member. The fibers shown in Table 2 are non-woven fabrics except those referred to as film.

### Examples 1 to 27 and Comparative Examples 1 to 5

The thus-prepared black ink and the wiping member were combined as shown in Table 2 to evaluate the wiping property of attached matter and the discharging stability.

### Evaluation on Wiping Property of Attached Matter

0.1 ml of the prepared ink shown in Table 1 was dripped on a nozzle plate of an inkjet head (MH5440, manufactured by Ricoh Co., Ltd.) and allowed to stand for 15 hours to prepare a nozzle plate to which the ink was attached (fixed). Next, a cleaning liquid having the following composition was applied to the wiping member shown in Table 2 with 20 μl/cm². Thereafter, the nozzle plate surface was wiped by the wiping member. The wiping conditions were: pressing force of 3 N; and wiping speed of 50 mm/s.

### Composition of Cleaning Liquid

| | |
|---|---|
| 3-methoxy-3-methyl-1-butanol | 20 percent by mass |
| (manufactured by KURARAY CO., LTD.): | |
| Polyether-modified silicone surfactant | 1 percent by mass |
| (WET270, manufactured by Evonik | |
| Degussa Japan Co., Ltd.): | |
| Deionized water: | Balance |

The nozzle plate after wiping was visually checked and removal of the attached ink was evaluated based on the number of wiping operations taken until the attached ink was removed. For the obtained results, the wiping members were determined as practically usable when graded C or above, preferable when graded B or above, and more preferable when graded A. The results are shown in Table 2.

### Evaluation Criteria

A: Attached ink on nozzle plate was removed by five or less wiping operations.
B: Attached ink on nozzle plate was removed by wiping operations six or seven times
C: Attached ink on nozzle plate was removed by wiping operations eight to ten times
D: Attached ink remained after wiping operations ten times

### Evaluation of Discharging Stability

The inks shown in Table 1 were mounted on an inkjet printer (IPSio GXe3300, manufactured by Ricoh Co., Ltd.) and the discharging stability was evaluated by intermittent printing. First, after continuously printing a 100% duty print chart on My Paper (manufactured by NB S Ricoh Co., Ltd.) with a run length of 20 sheets, discharging was ceased for the next 20 minutes (downtime). Next, the state of the discharging and the downtime was sequentially repeated 50 times and the print chart was printed on a total of 1000 sheets. Further, when the same chart was printed again, the presence or absence of streaks, voids (dot missing), and jet disturbance in the solid portion of the 5 percent chart were visually checked and determined according to the following evaluation criteria. Grade B or above is practically usable and A is preferable. The results are shown in Table 2.

### Evaluation Criteria

A: None of streaks, voids, or jetting disturbance present in solid portion
B: Slight streaks, voids, and jetting disturbance present in solid portion
C: Streaks, voids, jetting disturbance present all over the solid portion

TABLE 2

| | Ink | Used fiber | | Thickness (mm) | |
|---|---|---|---|---|---|
| | Preparation | First | Second | First | Second |
| | Example | layer | layer | layer | layer |
| Example 1 | 1 | Polyester | Rayon | 0.06 | 0.25 |
| Example 2 | 2 | Polyester | Rayon | 0.06 | 0.25 |
| Example 3 | 3 | Polyester | Rayon | 0.06 | 0.25 |
| Example 4 | 1 | Polyester | Rayon | 0.06 | 0.25 |
| Example 5 | 1 | Polyester | Rayon | 0.06 | 0.25 |
| Example 6 | 1 | Polyester | Rayon | 0.06 | 0.25 |
| Example 7 | 1 | Polyester | Rayon | 0.06 | 0.25 |
| Example 8 | 1 | Polyester | Rayon | 0.06 | 0.25 |
| Example 9 | 1 | Polyester | Rayon | 0.06 | 0.25 |
| Example 10 | 1 | Polyester | Rayon | 0.06 | 0.25 |
| Example 11 | 1 | Polyester | Rayon | 0.06 | 0.25 |
| Example 12 | 1 | Polyester | Rayon | 0.06 | 0.25 |
| Example 13 | 1 | Polyester | Rayon | 0.06 | 0.25 |
| Example 14 | 1 | Polyester | Rayon | 0.06 | 0.25 |
| Example 15 | 1 | Polyester | Rayon | 0.06 | 0.25 |
| Example 16 | 1 | Polyester | Rayon | 0.06 | 0.25 |
| Example 17 | 1 | Polyester | Rayon | 0.06 | 0.25 |
| Example 18 | 1 | Polyester | Rayon | 0.06 | 0.25 |
| Example 19 | 1 | Polyester | Rayon | 0.06 | 0.25 |
| Example 20 | 1 | Polyester | Rayon | 0.06 | 0.25 |
| Example 21 | 1 | Polyester | Rayon | 0.06 | 0.25 |
| Example 22 | 1 | Polyester | Rayon | 0.06 | 0.25 |
| Example 23 | 1 | Polyester | Rayon | 0.12 | 0.50 |
| Example 24 | 1 | Polyester | Rayon | 0.05 | 0.10 |
| Example 25 | 1 | Polyolefin | Rayon + | 0.06 | 0.25 |
| | | | Polyolefin | | |
| Example 26 | 1 | Polyester | Polyolefin | 0.06 | 0.25 |
| | | | porous | | |
| | | | material | | |
| Example 27 | 1 | Polyester | Rayon + | 0.06 | 0.25 |
| | | | PET film | | |
| Example 28 | 1 | Polyester | Rayon (two | 0.06 | 0.10/0.12 |
| | | | layers) | | |
| Comparative | 4 | Polyester | Rayon | 0.06 | 0.25 |
| Example 1 | | | | | |
| Comparative | 1 | Polyester | Rayon | 0.06 | 0.25 |
| Example 2 | | | | | |
| Comparative | 1 | Polyester | Rayon | 0.30 | 0.10 |
| Example 3 | | | | | |
| Comparative | 1 | Polyester | Rayon | 0.12 | 0.50 |
| Example 4 | | | | | |
| Comparative | 1 | Polyester | Rayon | 0.12 | 0.05 |
| Example 5 | | | | | |

| | Ink | Porosity | | Evaluation result | |
|---|---|---|---|---|---|
| | Preparation | First | Second | Wiping | Discharging |
| | Example | layer | layer | property | stability |
| Example 1 | 1 | 0.80 | 0.82 | A | A |
| Example 2 | 2 | 0.80 | 0.82 | A | A |
| Example 3 | 3 | 0.80 | 0.82 | A | B |
| Example 4 | 1 | 0.58 | 0.80 | C | A |
| Example 5 | 1 | 0.60 | 0.80 | B | A |
| Example 6 | 1 | 0.74 | 0.80 | B | A |
| Example 7 | 1 | 0.75 | 0.80 | A | A |
| Example 8 | 1 | 0.81 | 0.82 | B | A |
| Example 9 | 1 | 0.85 | 0.87 | B | A |
| Example 10 | 1 | 0.88 | 0.90 | C | A |
| Example 11 | 1 | 0.58 | 0.99 | C | A |
| Example 12 | 1 | 0.60 | 0.99 | B | A |
| Example 13 | 1 | 0.74 | 0.99 | B | A |
| Example 14 | 1 | 0.75 | 0.99 | A | A |
| Example 15 | 1 | 0.80 | 0.99 | A | A |
| Example 16 | 1 | 0.81 | 0.99 | B | A |
| Example 17 | 1 | 0.85 | 0.99 | B | A |
| Example 18 | 1 | 0.88 | 0.99 | C | A |
| Example 19 | 1 | 0.60 | 0.78 | C | A |
| Example 20 | 1 | 0.74 | 0.78 | C | A |
| Example 21 | 1 | 0.75 | 0.78 | B | A |
| Example 22 | 1 | 0.77 | 0.88 | A | A |
| Example 23 | 1 | 0.75 | 0.80 | A | A |
| Example 24 | 1 | 0.75 | 0.80 | A | A |
| Example 25 | 1 | 0.77 | 0.88 | A | A |
| Example 26 | 1 | 0.77 | 0.88 | A | A |
| Example 27 | 1 | 0.77 | 0.88 | A | A |
| Example 28 | 1 | 0.77 | 0.82/0.95 | A | A |
| Comparative | 4 | 0.80 | 0.82 | A | C |
| Example 1 | | | | | |
| Comparative | 1 | 0.85 | 0.81 | D | A |
| Example 2 | | | | | |
| Comparative | 1 | 0.78 | 0.92 | D | A |
| Example 3 | | | | | |
| Comparative | 1 | 0.85 | 0.81 | D | A |
| Example 4 | | | | | |
| Comparative | 1 | 0.85 | 0.81 | D | A |
| Example 5 | | | | | |

In Table 2, rayon+polyolefin represents a non-woven fabric made of a mixture of rayon fiber and polyolefin fiber with a mass ratio of 50:50 and polyolefin-based porous material represents a porous material made of polyolefin-based resin. Rayon+PET film represents a non-woven fabric made of rayon fiber lined with a film made of polyethylene terephthalate and rayon (two layers) represents two pieces of non-woven fabric made of rayon fibers bonded together.

The thickness of 0.10/0.12 indicating the thickness of the second layer in Example 28 in Table 2 indicates that the thickness of one non-woven fabric made of rayon fiber is 0.10 mm and that of the other non-woven fabric is 0.12 mm. The porosity of 0.82/0.95 indicating the porosity in Example 28 is that the porosity of one non-woven fiber made of rayon fiber is 0.82 while the porosity of the other is 0.95.

As seen in the comparison between Examples and Comparative Example 1, discharging stability was found to deteriorate when the number of types of alcohols was less than 2.

As seen in the comparison between Examples and Comparative Examples 2, 4 and 5, wiping ability for attached ink was found to deteriorate when the porosity of the first layer was greater than the porosity of the second layer.

As seen in the comparison between Examples and Comparative Example 3, wiping ability for the attached ink was found to deteriorate when the thickness of the first layer was greater than the total thickness of the layers other than the first layer.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A liquid discharging device comprising:
a liquid comprising two or more types of alcohols;
a liquid discharging head configured to discharge the liquid from a nozzle; and
a wiping member configured to wipe a nozzle forming surface of the liquid discharging head,
wherein the wiping member comprises two or more layers,
wherein a first layer of the two or more layers that is in contact with the nozzle forming surface has a porosity smaller than a porosity of at least one layer of the two or more layers other than the first layer,
wherein the first layer has a thickness thinner than a total thickness of the two or more layers other than the first layer.

2. The liquid discharging device according to claim 1, wherein at least one of the two or more types of alcohols comprises a glycol having a main chain length of 4 or less.

3. The liquid discharging device according to claim 1, wherein the first layer has a porosity of from 0.60 to 0.85.

4. The liquid discharging device according to claim 1, wherein the first layer has a porosity of from 0.75 to 0.80.

5. The liquid discharging device according to claim 1, wherein at least one of the two or more other layers other than the first layer has a porosity of from 0.80 to 0.99.

6. The liquid discharging device according to claim 1, wherein the first layer is made of non-woven fabric.

7. The liquid discharging device according to claim 1, wherein the wiping member has a thickness of from 0.1 to 3.0 mm.

8. A wiping method comprising:
wiping a nozzle forming surface of a liquid discharging head configured to discharge a liquid from nozzle with a wiping member,
wherein the liquid comprises two or more types of alcohols,
wherein the wiping member comprises two or more layers,
wherein a first layer in contact with the nozzle forming surface has a porosity smaller than a porosity of at least one layer of the two or more layers other than the first layer,
wherein the first layer has a thickness thinner than a total thickness of the two or more layers other than the first layer.
